(19) United States
(12) Patent Application Publication
(10) Pub. No.: US 2012/0324664 A1
(43) Pub. Date: Dec. 27, 2012

(54) FLEXIBLE TOOTHBRUSH WITH RIGID HANDLE SUPPORT

(76) Inventor: Don Allen Carpenter, Richmond, VA (US)

(21) Appl. No.: 13/167,987

(22) Filed: Jun. 24, 2011

(51) Int. Cl. A46B 9/04; A46D 3/00; B25G 1/00

(52) U.S. Cl. 15/143.1; 300/21

(57) ABSTRACT

The current invention relates to a flexible toothbrush with a rigid handle support that is also compact in size and shape and can be safely used by prison inmates. In order to allow for adequate handle length and still allow for the required radial, axial, and rotational direction flexibility, there needs to be in place on or more structural units within the elongated body and handle portions of the toothbrush that also provide enough support and rigidity in the longitudinal direction so that the user can accomplish the task with the same feel and ability accomplished with conventional toothbrushes that possess rigid thermoplastic or thermoset handles. For the purposes of the present application, a truss is a structure comprising one or more triangular sections provides the necessary support along the longitudinal length of the handle while still allowing enough flexibility that the toothbrush cannot be used as a weapon.

### FIELD OF THE INVENTION

The present invention describes a toothbrush and methods of making and using it. More specifically the invention relates to a flexible toothbrush with a rigid handle support that is also compact in size and shape and is safely used by prison inmates.

### BACKGROUND ART

Prison and other detention systems monitor devices permitted to be used by inmates to prevent the use of otherwise safe devices as a weapon. For example, conventional toothbrushes are not permitted to be used by many prison systems because they may be fashioned into a pointed shaft or rod or otherwise used as a shank for a sharp objects such as a razor blades, which could be used to endanger other inmates as well as security personnel.

In an attempt to provide a safe alternative toothbrush for use by inmates for dental hygiene purposes, a toothbrush is currently being used which includes a brush head and a very short handle. The handle is so short that it must be grasped by only the thumb and forefinger of the user. However, such a toothbrush is awkward to use. The fingers of the user may be required to enter the mouth to reach all of the teeth. Such a difficult to use toothbrush may result in inadequate teeth cleaning, and be awkward and uncomfortable to use. Such ineffectual cleaning procedures may cause, or at the least contribute to, poor dental hygiene, thereby leading to costly dental procedures in some instances. In order to increase the handle length and still allow for the required radial, axial, and rotational direction flexibility (also allowing for torsional flexibility), there needs to be in place on or more structural units within the elongated body and handle portions of the toothbrush that also provide enough support and rigidity in the longitudinal direction so that the user can accomplish the task with the same feel and ability accomplished with conventional toothbrushes that possess rigid thermoplastic or thermoset handles.

To accomplish this, the use of a truss or strut as structural components providing the structural unit within the handle provides the necessary support along the longitudinal length of the handle. For the purposes of the present application, a strut is defined as a structural component designed to resist longitudinal compression. Struts provide outwards-facing support in their lengthwise direction, which can be used to keep two other components separate, performing the opposite function of a tie. Struts are commonly used in architecture and engineering, for instance as components of an automobile chassis, where they can be passive braces to reinforce the chassis and/or body, or active components of the suspension. The strut, for example in automotive suspension combines the primary function of a shock absorber (as a damper), with the ability to support sideways loads not along its axis of compression, somewhat similar to a sliding pillar suspension, thus eliminating the need for an upper suspension arm. This means that a strut must have a more rugged design, with mounting points near its middle for attachment of such loads.

For the purposes of the present application, a truss is a structure comprising one or more triangular sections. Trusses are composed of triangles because of the structural stability of that shape and design. A triangle is the simplest geometric figure that will not change shape when the lengths of the sides are fixed. In comparison, both the angles and the lengths of a four-sided figure must be fixed for it to retain its shape.

The triangular units are constructed with straight members whose ends are connected at joints referred to as nodes. External forces and reactions to those forces are considered to act only at the nodes and result in forces in the members which are either tensile or compressive forces. Moments (torques) are normally excluded because, and only because, all the joints in a truss are treated as revolutes. A planar truss is one where all the members and nodes lie within a two dimensional plane, while a space truss has members and nodes extending into three dimensions.

The Vierendeel truss (also referred to as a bridge) is a truss where the members are not triangulated but form rectangular openings, and is a frame with fixed joints that are capable of transferring and resisting bending moments. As mentioned above, regular trusses comprise members that are commonly assumed to have pinned joints, with the implication that no moments exist at the jointed ends. For the present application, it is necessary that the strut or truss utilized will allow for bending moments at certain locations within the handle such as is the case with the Vierendeel truss, but also allow for diagonal elements that endure proper load distribution such that the handle of the toothbrush can be torsionally twisted and also provide for longitudinal and axial stability. The handle is comprised of flexible thermoplastic(s) components that separately and individually are neither rigid nor provide support. Thus, the necessity for the use of struts or trusses as included in the design features shown in the figures herewithin.

### BRIEF DESCRIPTION OF THE DRAWINGS

The following is a brief description of the drawings:

FIG. 1 is a left oblique view of the toothbrush, which is constructed according to an embodiment of the invention;

FIG. 2 is a left elevation view of the toothbrush of FIG. 1;

FIG. 3 is a right elevation view of the toothbrush of FIG. 1;

FIG. 4 is a top view of the toothbrush of FIG. 1;

FIG. 5 is a bottom view of the toothbrush of FIG. 1; and

FIG. 6 is an end view of the toothbrush of FIG. 1.

FIG. 7 is a left oblique view of the bristle brush head and the narrow portion of the toothbrush of FIG. 1.

### DETAILED DESCRIPTION OF CERTAIN EMBODIMENTS OF THE INVENTION

The disclosed embodiments relate to a toothbrush (2) and methods of making and using it, wherein an elongated body (6) has a bristle brush head (4) portion and a handle (8) portion. The body (6) and the handle (8) portions are both composed of flexible (thermoplastic) materials so that the handle (8) portion can be grasped in the hand of the user and used in the same manner as a conventional toothbrush handle while still allowing the user to flex and twist the elongated body (6), handle (8) and bristle brush head (4) before, during, and after use allowing for proper teeth brushing purposes.

### DETAILED DESCRIPTION OF THE INVENTION

The disclosed embodiments relate to a toothbrush and methods of making and using it, wherein an elongated body (6) has a bristle brush head (4) portion and a flexible handle (8) portion, wherein the handle (8) portion includes struts or trusses (10) that provide sufficient rigidity in the radial, axial, and rotational directions (while still allowing for torsional flexing) such that bending moments are limited but allowing sufficient compressive and tensile strength as well as flexibility to ensure the handle (8) and body (6) portion, in their most rigid form can not be used as a weapon or as a rigid “pick-like” instrument. The body (6) and handle (8) are comprised of flexible material so that the handle (8) portion can be grasped in the hand of the user, and the user can flex the elongated body (6) and handle (8), but such that the handle (8) is substantially rigid to allow for proper teeth brushing purposes.

According to other embodiments, the length (24) of the body (6), handle (8) and bristle brush head (4) portions is up to about 4.5 inches.

According to further embodiments, the compositional materials of the toothbrush are flexible, durable, and moldable and also provide a Shore A durometer hardness of between about 75 and about 95.

According to still other embodiments of the invention, the material of the body (6) may be composed of an extrudable thermoplastic and/or elastomer selected from the group consisting of silicone, neoprene, EPDM, nitrile, fluoroelastomers, natural rubber, styrene-butadiene rubber, thermoplastic elastomers, polyvinyl alcohol, PMMA, polyamide, polyester terephthalate, polycarbonate, polyetherimide, polyethylene (LDPE, HDPE, LLDPE, and blends), polypropylene and copolymers, polysulfone, polyvinyl chloride, butylated and/or carboxylated nitrile, polysulfides, alpha olefin elastomers, conjugated diene elastomers, hydrogenated diene elastomers, ethylene carboxylate, ethylene-propylene-diene elastomers, functionalized ethylene-vinyl acetate, SB-diblock copolymers, SBS and SIBS-triblock copolymers, and acrylic rubber.

According to further embodiments of the invention, there is provided a method of using a toothbrush (2) by grasping the handle (8) portion in the hand of the user, without requiring pressing on a portion of the elongated body (6) of the toothbrush by the user to flex the elongated body (6) into a substantially rigid flexed position, in that the body (6) and handle (8) portion are supported by struts or trusses (10) that provide sufficient rigidity to use the handle as if it were the handle of a conventional toothbrush handle. The teeth may then be brushed for cleaning purposes.

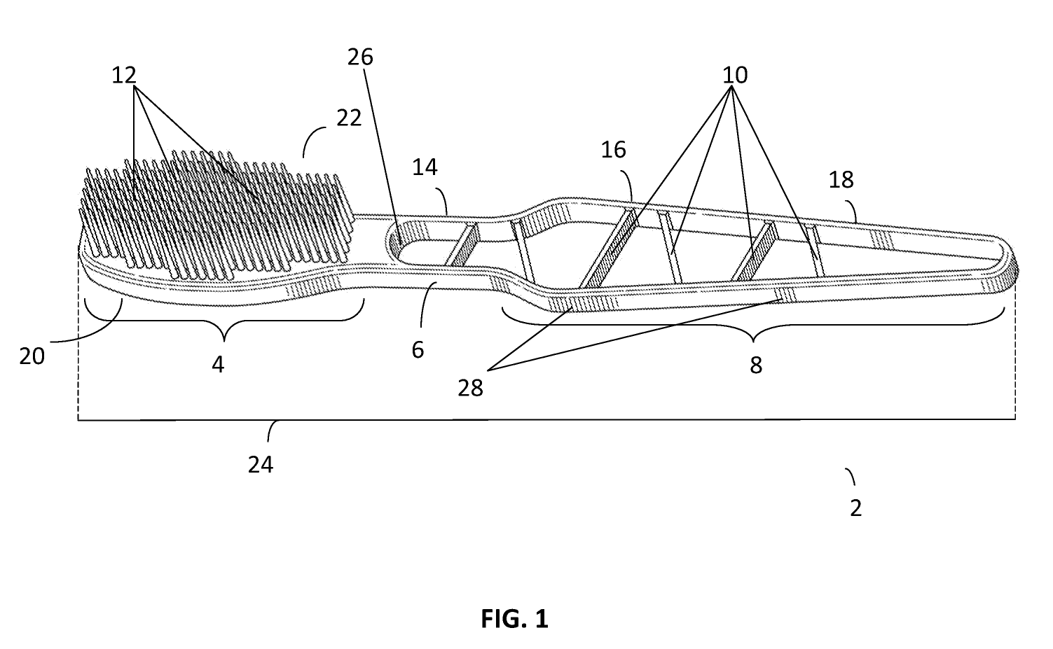

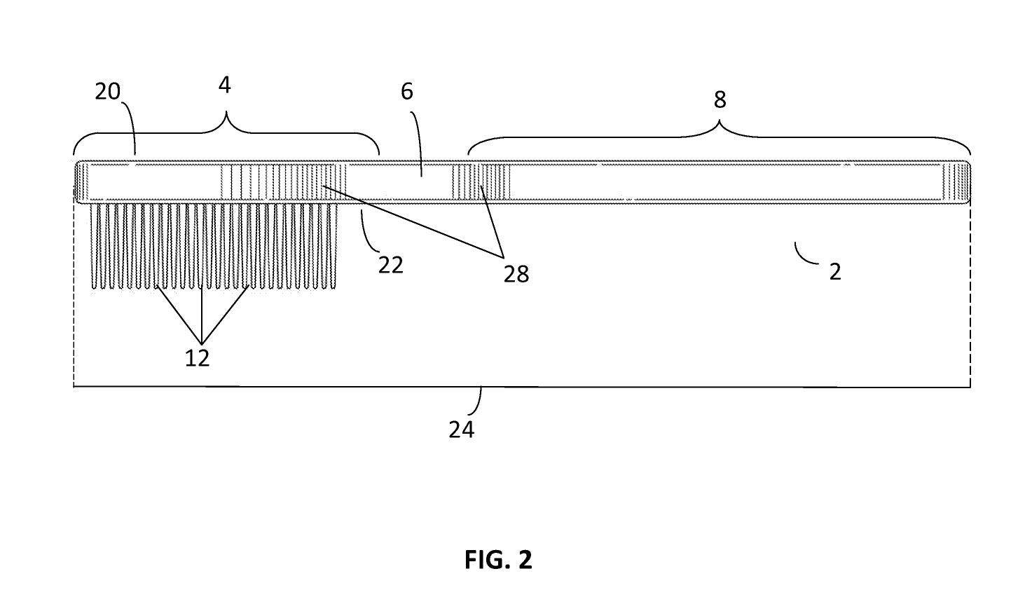

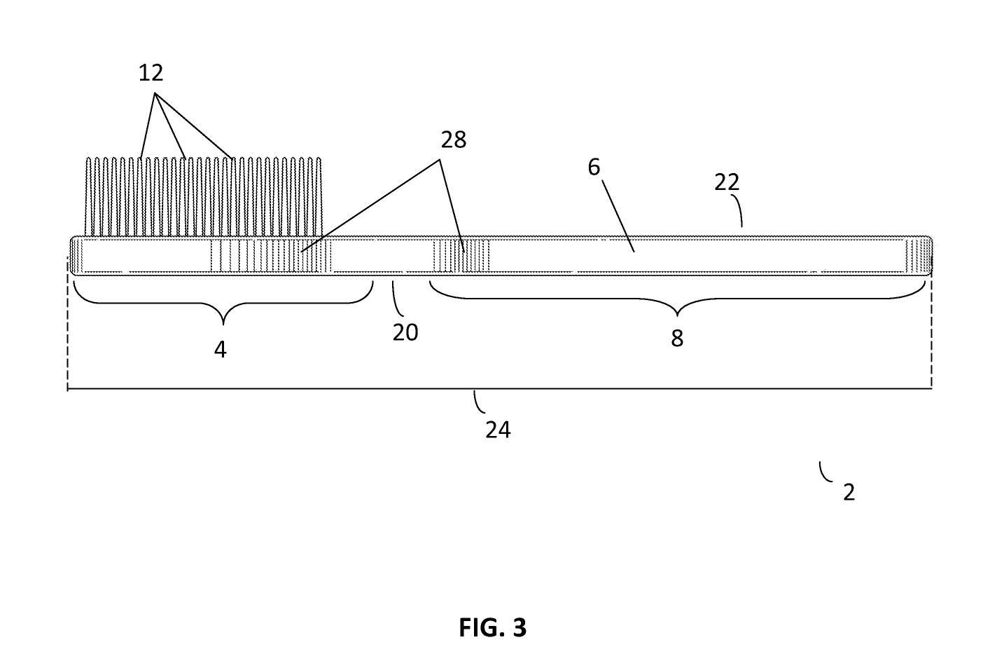

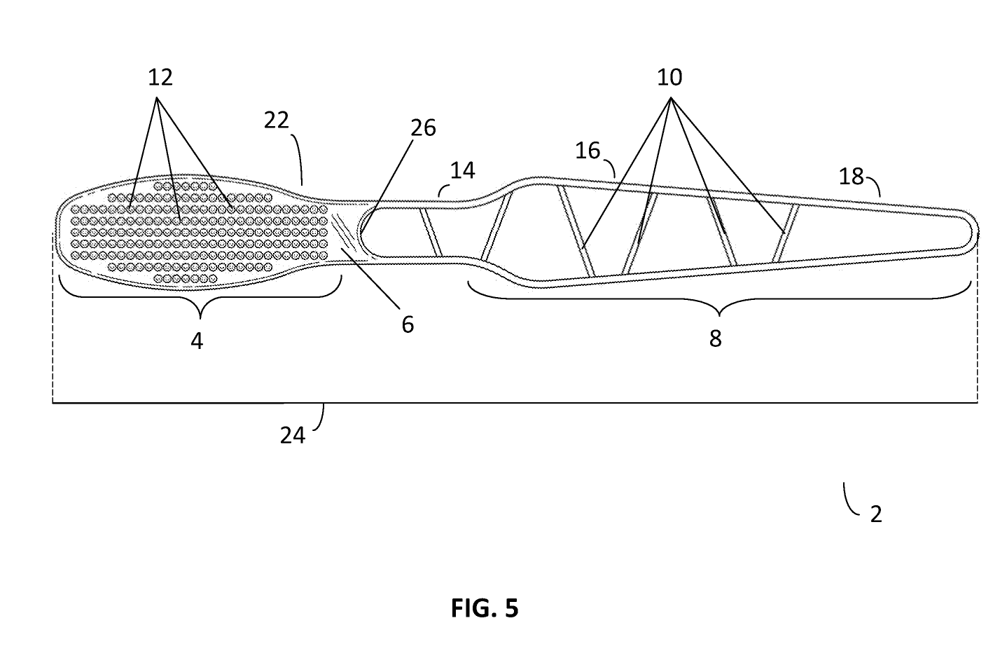

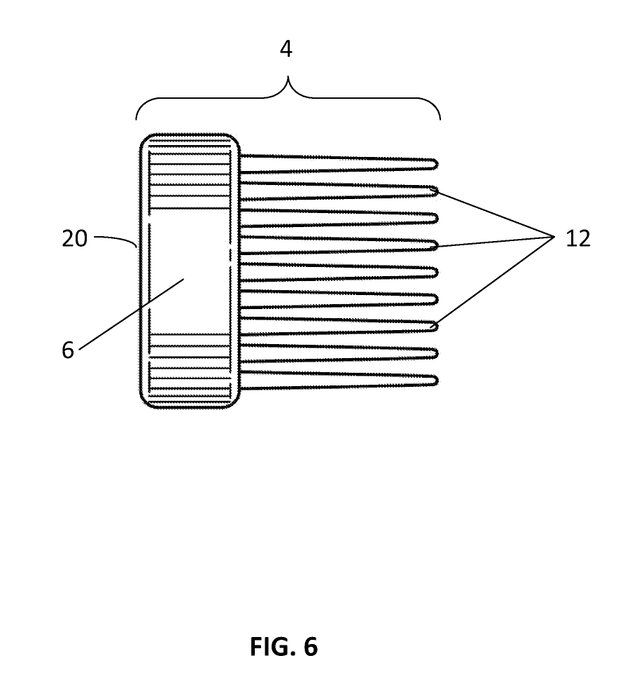

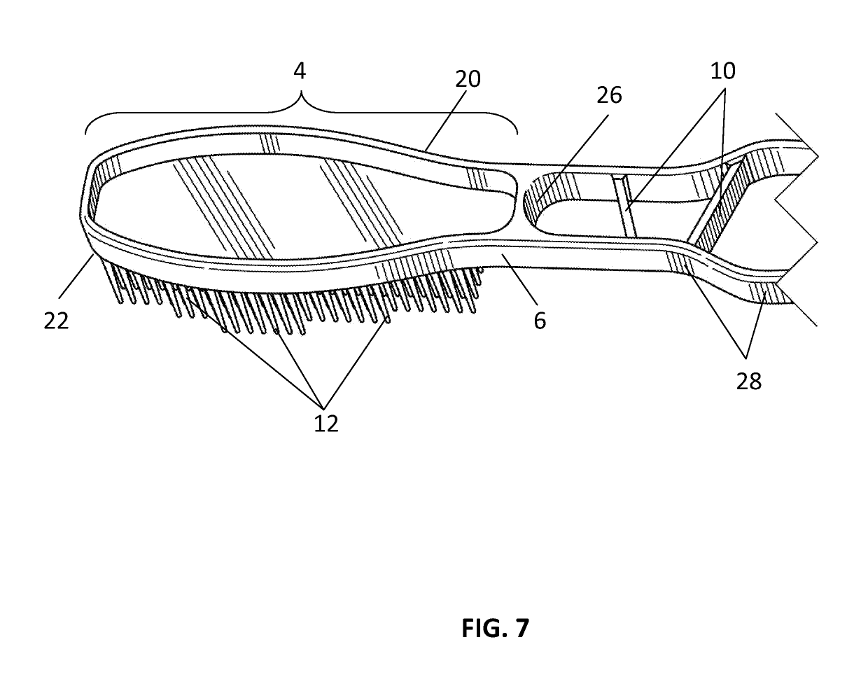

Referring now to the drawings, and more particularly to FIGS. 1-7 thereof, there is shown a toothbrush (2), which may be constructed in accordance with an embodiment of the invention. The toothbrush (2) includes an elongated body (6), a handle (8), having a bristle brush head (4) portion having a bristles (12) extending therefrom. The elongated body (6) and handle (8) provides at least one or more struts or trusses (10) connecting the narrowed portion (14), intermediate portion (16), and end portion (18) of the body (6) and handle (8) sections that are integrally connected with the top portion (20) and bottom portion (22) of the elongated body (6) and handle (8).

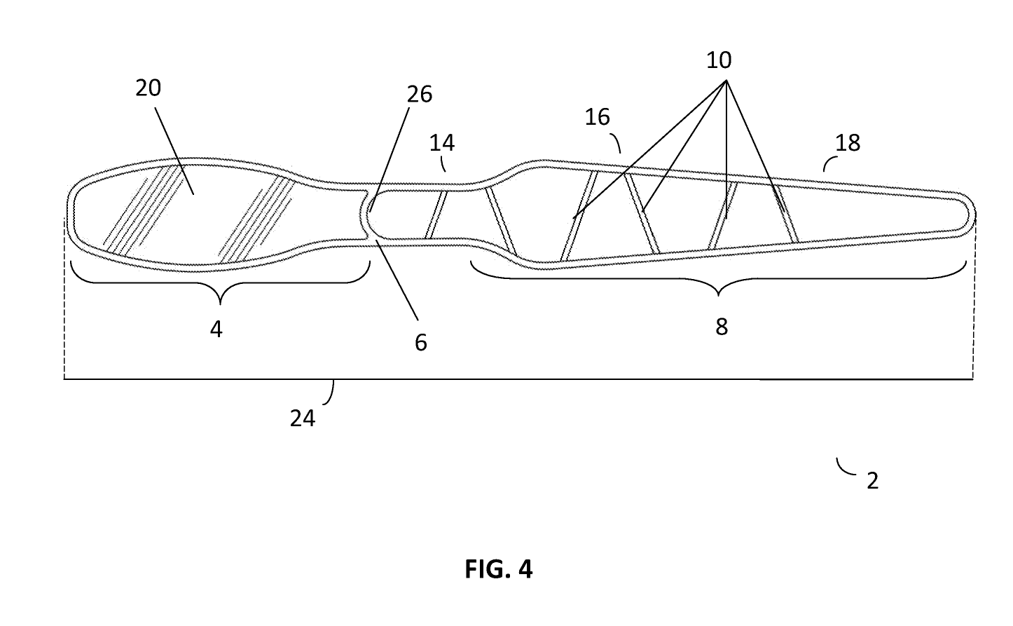

As best seen in FIG. 4, the body (6) portion preceding the handle (8) portion (moving from the bristle brush head (4) portion toward the end of the handle (8) portion) illustrates the use of a curved strut (26) that connects the top portion (20) and bottom portion (22) of the body (6) and handle (8), thereby further proper support between the body (6) and the bristle brush head (4) portions so that handle (8), body (6) and bristle brush head (4) all can act as a single unit when the user is brushing his or her teeth

In use, the toothbrush (2) design of the present invention provides nearly the same or very similar utility as a conventional toothbrush and can be used as if the toothbrush was conventional in that the handle (8) provides the necessary rigidity so the prisoner can still move the toothbrush (2) in all directions (vertical, horizontal, and all angles between zero and 180 degrees) while brushing their teeth without being able to use the toothbrush (2) as a weapon or a pick like device.

For the purposes of safety (i.e. prison market) the length of the body (6) of the toothbrush (2) should be up to approximately 4½ inches in length (24). More preferably, the length of the body (6) is between about 3.0 inches and 4.5 inches. Still more preferably, the length (24) of the body (6) is between about 3.5 inches and about 4.5 inches. The most preferred length (24) of the body (6) is about 4.5 inches.

The bristle brush head (4) portion may have wider bristle brush head (4) portion than as shown in FIGS. 1-7. Also, the intermediate portion (16) may vary in width, and may be wider than the intermediate portion (16) shown in FIGS. 1-7. Additionally, the hardness of the material of the body (6) and handle (8) can vary, depending on the degree of safety desired and the selection of the material. A harder material may affect the need for more pressure exertion by the fingers of the user. The preferred hardness is a durometer hardness of between about 75 and about 95.

It should be understood that the toothbrush (2) may be used for a variety of purposes. It may be used for cleaning the teeth of animals such as pets. The toothbrush (2) may be used in travel kits due to its compact size. For such applications, a harder material may be used, and result in less reliance on the digit pressing on the irregular/gripping surface (28) to guide the bristle brush head (4) portion and the length (24) of the brush (2) may vary. For example, a longer handle (8) portion and less flexible material may be employed for a larger pet.

The more flexible the materials, the less safety risk (for the prison environment). The hardness of the material directly affects the flexibility. Different hardness of the material or different materials used, may allow for tailoring the toothbrush (2) to meet a range of safety concerns needed from maximum security prisons (the highest) down to minimum security prisons.

The bristles (12) may be the same type or quality as are found in conventional toothbrushes, and may be soft, medium or firm. Oval shaped bristles may be employed, but other shapes such as square may be employed as well.

The toothbrush (2) when used in correctional facilities will lessen the risk to inmates and correctional officers from an inmate using the toothbrush (2) or modifying it as a slashing weapon device. Inmates can fashion a weapon from a conventional hard plastic toothbrush by using it as a pick device, a jabbing device, or by cutting a notch in the head or bottom of the handle to insert a razor blade, and possibly melt the material around the razor blade (or glass or similar sharp material) to hold the sharp object in place. After the melted area cools, such a device becomes a dangerous weapon for the use described. The embodiment of the invention may substantially lessen or eliminate the fashioning of such a device, because the material may not have the strength and rigidity of a conventional stiff handled toothbrush.

The toothbrush (2) may be constructed of a transparent material, in part or all. The correctional market desires products that are either constructed of transparent material to lessen the possibility of contraband being hidden. For the retail or pet markets, solid colored material may be employed.

Many conventional toothbrushes are designed with a lengthy handle, usually with some ergonomic design, but usually with an overall design to condition the user to grasp the handle with the entire hand and bring the entire stiff handled device to bear force and pressure on the teeth and gums. Such operation is desirable in that it represents the conventional approach to using a toothbrush and brushing one's teeth. One embodiment of the present disclosure is to provide the toothbrush (2) with a handle (8) that functions in the same or a similar manner to the conventional toothbrush design but also providing a toothbrush (2) that is flexible and harmless in that it cannot function as a weapon or a pick like device.

A conventional long handled toothbrush requires twisting or manipulation of the hand and wrist. Whereas, the toothbrush (2) of the present invention also allows for these motions by employing the struts and/or trusses (10) that ensure structural integrity as well as flexibility.

The different materials of construction to construct the handle (8) will also have some features to lessen slippage when the device is wet. Conventional toothbrushes use similar materials, such as the tactile feel of rubber.

Although the toothbrush (2) is currently preferred to accommodate the prison environment, the pet market could use a larger size body (6) to provide a longer handle (8). A possible application could also include the retail market and the travel kit market (space requirements for travel kits necessitates downsized articles—i.e., a short handle toothbrush) or a device with a handle extension.

The bristles (12) (number of cavities, and tufts or strands per cavity) should be similar to any conventional toothbrush. The bristle brush head (4) portion may vary in size, and may be sized to the mouth of an average user. Also, there may be different angles for the bristles (12). The bristles (12) may be inserted after the material of the body (6) partially or completely cools during injection molding.

There may be different methods being used to insert the bristles. It should be noted that only a portion of the body (6) may be flexible or otherwise deformable. A variety of material hardness of the body (6) and the handle (8) may be employed.

Various modifications and changes may be made with respect to the foregoing detailed description certain embodiments of the invention as will become apparent to those skilled in the art without departing from the spirit of the present invention.

What is claimed is:

1. A toothbrush, comprising: a body portion, an elongated handle portion, and a head brush portion, said body portion extending between said brush head portion and a distal end of said handle portion includes an elongated smoothly rounded bulbous handle end portion and said head brush portion includes enlarged smoothly rounded bristle brushes, wherein said body portion, handle portion, and said brush head portion are all integrally connected into a single frame forming said toothbrush and wherein said body and said elongated handle portion have a top side and a bottom side; a length along a longitudinal axis, a width along the top and bottom side extending perpendicular to said longitudinal axis and a thickness extending perpendicular to said longitudinal axis between said top and bottom side of said body and handle portion, wherein said body portion is directly connected to said head brush portion and wherein said brush head portion includes a group of bristles located only on a bottom side of said head brush portion; said bristles each having a length substantially the same as the width of the group of bristles on said bottom side; said body and handle being integral and composed of a sufficiently pliable flexible material throughout the length of said body portion and said handle portion wherein said handle portion being pliable and flexible along its entire length includes at least one strut and/or one truss connecting said top side and said bottom side of said handle portion and optionally at least one strut and/or truss connecting said top side and said bottom side of said body portion integrally connecting the enlarged head portion and the enlarged handle end portion substantially midway therebetween to facilitate flexing of the toothbrush in an axial, radial, and rotational direction along said longitudinal axis.

2. A toothbrush according to claim 1, wherein the compositional materials of said toothbrush is flexible, durable, and moldable and also provides a Shore A durometer hardness of between about 75 and about 95.

3. A toothbrush according to claim 2, wherein said compositional materials are extrudable thermoplastic(s) or thermoplastic elastomer(s).

4. A toothbrush according to claim 3, wherein said compositional materials are selected from at least one of the group consisting of; polyurethane, silicone, neoprene, EPDM, nitrile, fluoroelastomers, natural rubber, styrene-butadiene rubber, thermoplastic estomers, polyvinyl alcohol, PMMA, polyamide, polyester terephthalate, polycarbonate, polyetherimide, polyethylene (LDPE, HDPE, LLDPE, and blends), polypropylene and copolymers, polysulfone, polyvinyl chloride, a butylated or carboxylated nitrile, polysulfides, olefinic alpha-elastomers, conjugated diene elastomers, hydrogenated diene elastomers, ethylene carboxylate, ethylene-propylene-diene elastomers, functionalized ethylene-vinyl acetate, SB-diblock copolymers, SBS and SIBS-triblock copolymers, and acrylic rubbers.

5. A toothbrush according to claim 4, wherein the length of said body and said handle is between about 3.0 inches and about 4.5 inches.

6. A toothbrush according to claim 5, wherein the length of said body and said handle is about 3.5 inches.

7. A toothbrush according to claim 6, wherein said handle portion is wider than said brush head portion with said narrowed intermediate portion located within said body therebetween.

8. A toothbrush according to claim 1, wherein said body includes a curved strut extending between said brush head and said body portion.

9. A method of making a toothbrush, comprising: molding a body and handle portion of a pliable flexible material, including molding said body and handle portion to include a brush head portion; wherein said body portion, handle portion, and said brush head portion are all integrally connected into a single frame forming said toothbrush and wherein said body and said elongated handle portion have a top side and a bottom side; a length along a longitudinal axis, a width along the top and bottom side extending perpendicular to said longitudinal axis and a thickness extending perpendicular to said longitudinal axis between said top and bottom side of said body and handle portion, wherein said body portion is directly connected to said head brush portion and wherein said brush head portion includes a group of bristles located only on a bottom side of said head brush portion; said bristles each having a length substantially the same as the width of the group of bristles on said bottom side; said body and handle being integral and composed of a sufficiently pliable flexible material throughout the length of said body portion and said handle portion wherein said handle portion being pliable and flexible along its entire length includes at least one strut and/or one truss connecting said top side and said bottom side of said handle portion and optionally at least one strut and/or truss connecting said top side and said bottom side of said body portion integrally connecting the enlarged head portion and the enlarged handle end portion substantially midway therebetween while imparting rigidity and flexibility to said toothbrush in an axial, radial, and rotational direction along said longitudinal axis.

10. The method of making the toothbrush of claim 9, wherein said body includes a curved strut extending between said brush head and said body portion.

11. The method of making the toothbrush of claim 9, wherein the materials of construction are selected from at least one of the group consisting; of polyurethane, silicone, neoprene, EPDM, nitrile, fluoroelastomers, natural rubber, styrene-butadiene rubber, thermoplastic elastomers, polyvinyl alcohol, PMMA, polyamide, polyester terephthalate, polycarbonate, polyetherimide, polyethylene (LDPE, HDPE, LLDPE, and blends), polypropylene and copolymers, polysulfone, polyvinyl chloride, carboxylated nitrile, polysulfides, alpha olefin elastomers, conjugated diene elastomers, hydrogenated diene elastomers, ethylene carboxylate, ethylene-propylene-diene elastomers, functionalized ethylene-vinyl acetate, SB-diblock copolymers, SBS and SIBS-triblock copolymers, and acrylic rubber, wherein the flexibility of said materials of construction allows for said handle portion being pliable and flexible along its entire length thereby facilitating flexing of the toothbrush in an axial, radial, and rotational direction along said longitudinal axis while also allowing for structural rigidity of said handle portion.

12. The method of making a toothbrush according to claim 11, wherein the compositional material of said toothbrush is flexible, is durable, and moldable providing a Shore A durometer hardness of between about 75 and about 95.

13. The method of making a toothbrush according to claim 11, wherein said materials of construction are extrudable thermoplastic(s) or thermoplastic elastomer(s).

14. The method according to claim 9, wherein the length of said body and said handle is between about 3.0 inches and about 4.5 inches.

15. The method according to claim 14, wherein the length of said body and said handle is about 3.5 inches.

16. The method according to claim 9, wherein said handle portion is wider than said brush head portion with said narrowed intermediate portion therebetween.

17. The method according to claim 10, wherein said body includes a curved strut extending between said brush head and said body portion.
